(19) United States
(12) Patent Application Publication
(10) Pub. No.: US 2025/0052502 A1
(43) Pub. Date: Feb. 13, 2025

(54) FEED INLET STRUCTURE, BURNER AND METHOD FOR FEEDING MATERIAL TO BURNER

(71) Applicant: METSO METALS OY, Espoo (FI)

(72) Inventors: Peter BJÖRKLUND, Espoo (FI); Aki LAANINEN, Kirkkonummi (FI); Jaana ROMPPANEN, Espoo (FI)

(21) Appl. No.: 18/719,051

(22) PCT Filed: Dec. 17, 2021
(86) PCT No.: PCT/FI2021/050889

§ 371 Date: Jun. 12, 2024

(51) Int. Cl. F27D 99/00

(52) U.S. Cl. CPC F27D 99/0003; F27D 99/0033

(57) ABSTRACT

A feed inlet structure for a burner for a suspension smelting furnace includes an inlet space defined inside the feed inlet structure. The feed inlet structure further includes an inlet opening and a feed distributor provided at least partly within the inlet space. The feed distributor is configured to separate objects from a standard feed, which objects have a particle size that is larger than a maximum particle size of the standard feed. The feed distributor includes at least one dividing plate including a first side having a first surface. The first surface of each dividing plate is configured to deviate a trajectory of at least some objects from a trajectory of the standard feed inside the feed inlet structure, when feed material including standard feed and objects is fed to the feed inlet structure.

### BACKGROUND

The disclosure relates to feeding material to burners, and more particularly to burners for suspension smelting furnaces. The present disclosure further concerns a feed inlet structure, a burner, and a method for feeding material to a burner.

Feed material fed to burners, especially to burners for suspension smelting furnaces, may often comprise larger objects in addition to so called standard feed. These larger objects may affect the burning characteristics negatively. There have been attempts to prevent this problem by providing vertical plates or bars at an inlet opening of a feeding structure of the burner. This has, however, caused the objects to collect to the inlet opening and, eventually, to block the feed material flow to the burner. The larger objects mixed to the standard feed have also caused inconsistencies in the burning results.

### BRIEF DESCRIPTION OF THE DISCLOSURE

An object of the present disclosure is to provide a new feed inlet structure, a new burner and a new method for feeding material to a burner.

The object of the disclosure is achieved by the aspects which are characterized by what is stated in the independent claims. Some embodiments of the disclosure are disclosed in the dependent claims.

The embodiments and features, if any, described in this description, which do not fall under the scope of the independent claims, are to be interpreted as examples useful for understanding various embodiments of the disclosure. Some aspects of the disclosure are defined by the independent claims.

The disclosure is based on the idea of providing a feed distributor at least partly inside a feed inlet structure, the feed distributor comprising at least one dividing plate having a surface with a horizontal component.

An advantage of the disclosure is that feed distributor divides the feed material to standard feed following a first trajectory inside the feed inlet structure and to larger objects received by the dividing plate(s) and guided to a second trajectory inside the feed inlet structure. This may prevent blocking of the standard feed feeding to the burner and direct the larger objects further into feed inlet structure to improve burning characteristics of the burner.

### BRIEF DESCRIPTION OF THE DRAWINGS

In the following the disclosure will be described in greater detail by means of preferred embodiments with reference to the accompanying drawings, in which

FIG. 1 illustrates schematically a suspension smelting furnace seen from a side;

FIG. 2 illustrates schematically a burner for a suspension smelting furnace seen from a side as partially transparent;

FIGS. 3a, 3b and 3c illustrate schematically three embodiments of a feed inlet structure seen from the direction A-A of FIG. 2;

FIGS. 4a, 4b and 4c illustrate schematically three embodiments of a feed inlet structure seen from a side in cross section;

FIGS. 5a and 5b illustrate schematically two embodiments of a dividing plate seen from a side as partially transparent;

FIGS. 6a, 6b and 6c illustrate schematically details of two embodiments of a feed distributor;

FIGS. 7a and 7b illustrate schematically feed distributors according to two different embodiments seen in perspective; and

FIG. 8 illustrates a method for feeding material to a burner.

### DETAILED DESCRIPTION OF THE DISCLOSURE

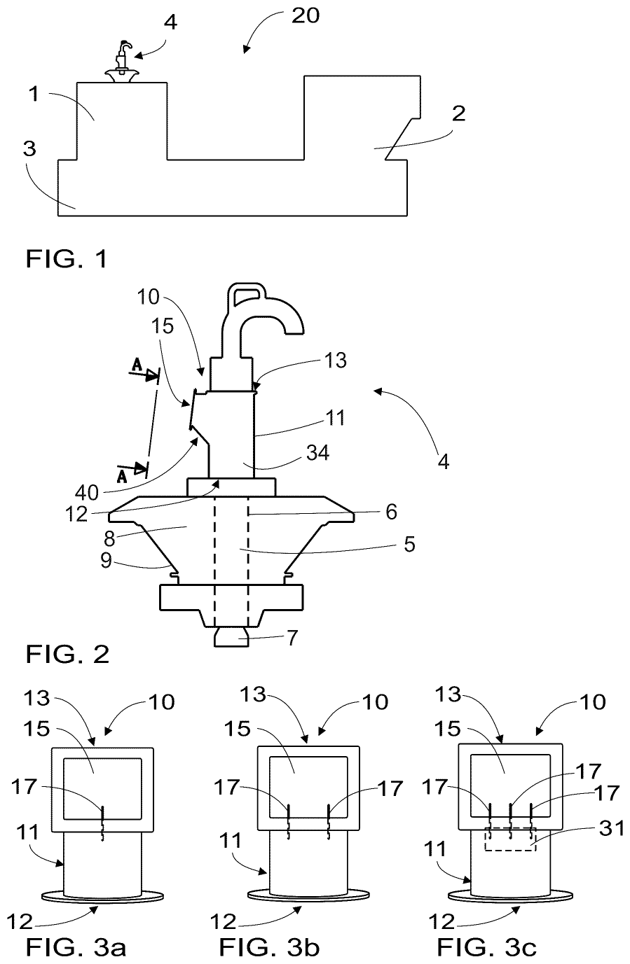

FIG. 1 illustrates schematically a suspension smelting furnace seen from a side, and FIG. 2 illustrates schematically a burner for a suspension smelting furnace.

A suspension smelting furnace 20, such as the suspension smelting furnace of FIG. 1, may comprise a reaction shaft 1, an uptake shaft 2, and a lower furnace 3, and a burner 4, such as a concentrate burner or a matte burner, for feeding reaction gas and feed material into the reaction shaft 1 of the suspension smelting furnace. A suspension smelting furnace 20 may comprise for instance a flash converting furnace or a flash smelting furnace.

A burner 4 for the suspension smelting furnace 20, such as the burner of FIG. 2, may comprise a feed inlet structure 10. The feed inlet structure 10 may be configured to receive feed material into the burner 4. According to an embodiment, the burner 4 may further comprise a feed material discharge channel 5. According to an embodiment, the feed material discharge channel 5 may be radially limited by a wall 6 of the feed material discharge channel. According to an embodiment, the feed inlet structure 10 may be configured to guide the feed material into the feed material discharge channel 5.

According to an embodiment, the burner may further comprise a feed material dispersion device 7 in the feed material discharge channel 5, and an annular air chamber 8 that surrounds the feed material discharge channel 5 and that is radially limited by a wall 9 of the annular reaction gas channel 8. Air may be supplied to the air chamber 8 via separate channels (not shown) connected to an upper side area of the air chamber 8. It is clear for a person skilled in the art that a burner 4 for suspension smelting furnace 20 may further comprise other structural parts not described here.

According to an embodiment, the burner 4 may comprise a concentrate burner or a matte burner.

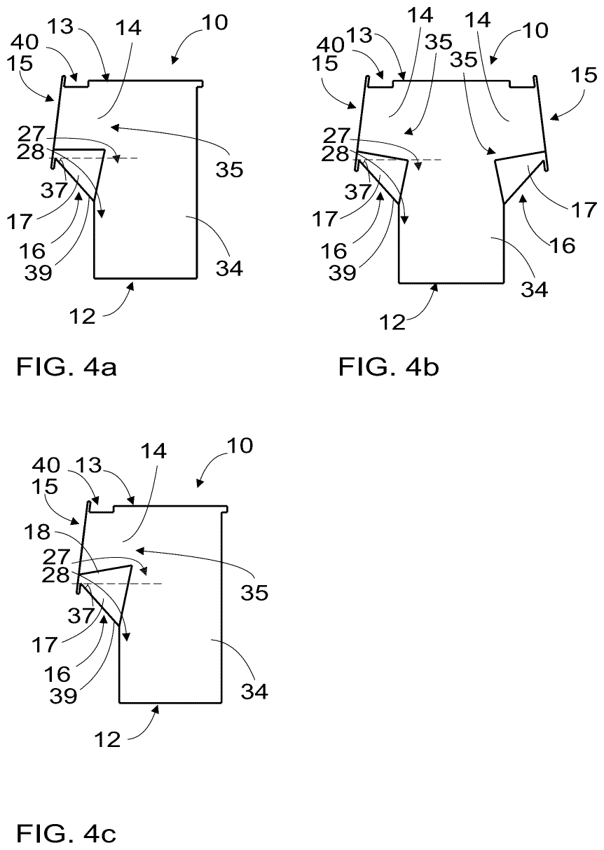

FIGS. 3a, 3b and 3c illustrate schematically three different embodiments of a feed inlet structure 10 seen from the direction A-A of FIG. 2. FIGS. 4a, 4b and 4c illustrate schematically three embodiments of a feed inlet structure seen from a side in cross section. FIGS. 6a, 6b and 6c illustrate schematically details of two embodiments of a feed distributor and FIGS. 7a and 7b illustrate schematically feed distributors according to two different embodiments seen in perspective.

A feed inlet structure 10, for instance a feed inlet structure of any one of FIGS. 3a, 3b, 3c, 4a, 4b and 4c, may be suitable for guiding feed material in a suspension smelting furnace 20. More particularly, a feed inlet structure 10 may be suitable for feeding feed material for a burner of a suspension smelting furnace 20. According to an embodiment, a feed inlet structure 10, such as the feed inlet structure of FIG. 3a, 3b, 3c, 4a, 4b or 4c, may be used for guiding feed material towards a feed material discharge channel 5.

A feed inlet structure 10 for a burner 4 for a suspension smelting furnace 20, such as the feed inter structure 10 of the FIG. 3a, 3b, 3c, 4a, 4b or 4c, comprises at least one side wall 11, a bottom 12 and a top 13. The bottom 12 and the top 13 may be provided at opposite ends of the at least one side wall 11. In other words, the at least one side walls 1 may comprise one or more walls of the feed inlet structure 10 provided between the top 13 and the bottom 12 of the feed inlet structure 10. The feed inlet structure 10 may comprise one or more separate structural parts.

The feed inlet structure 10 further comprises an inlet space 14 defined inside the feed inlet structure 10. According to an embodiment, the inlet space 14 is defined by the at least one side wall 11, the bottom 12 and the top 13. According to an embodiment, the bottom 12 and/or the top 13 may comprise at least one opening towards other structural parts of the burner 4.

According to an embodiment, the feed inlet structure 10 may comprise a round or elliptical cross section at least at one point along the feed inlet structure 10. In such embodiments, the feed inlet structure 10 may comprise one side wall 11 or two or more side walls 11.

According to an embodiment, the feed inlet structure may comprise a rectangular cross section at least at one point along the feed inlet structure 10. In such embodiments, the at least one side wall 11 may comprise four side walls 11. The four side walls 11 may comprise two pairs of side walls 11, each pair of side walls 11 comprising two side walls 11 spaced from each other. Each side wall 11 may be connected to two adjacent side walls 11 at corners of the feed inlet structure 10. The feed inlet structure 10 according to such an embodiment may further comprise a bottom 12 and a top 13 extending between the sides 11 at opposite ends of the side walls 11, namely the upper end and the lower end of the side walls 11, when seen in a typical use position of the feed inlet structure 10.

According to an embodiment, the inlet space 14 may be defined inside the feed inlet structure 10 by the at least one side wall 11, the bottom 12 and the top 13. According to an embodiment, wherein the feed inlet structure 10 comprises a rectangular cross section and the at least one side wall comprises two pairs of side walls, as described above, the inlet space 14 may be defined by the two pairs of side walls 11, the bottom 12 and the top 13.

According to an embodiment, such as in the embodiments of FIGS. 1, 2, 3a, 3b, 3c, 4a, 4b and 4c, the shape of the cross section of the feed inlet structure 10, more particularly the horizontal cross section, varies along the vertical direction of the feed inlet structure 10.

According to an embodiment, the feed inlet structure 10 may comprise a cross section, more particularly a horizontal cross section, of a shape different from a round, elliptical or rectangular shape at least at one point of along the vertical direction of the feed inlet structure 10.

According to an embodiment, the feed inlet structure 10 may comprise a vertical section 34 extending in a vertical direction in a use position of the feed inlet structure 10 and the burner 4, and a protruding section 40 protruding from the vertical section 34. Both the vertical section 34 and the protruding section 40 are preferably formed as hollow, tube-like, pipe-like or channel-like structures comprising one or more side walls 11 defining an inside space within each of the structures. The vertical section 34 and/or the protruding section may, in each case, comprise a round, elliptical and/or rectangular cross section and/or a cross section of a shape different from a round, elliptical or rectangular shape at least at one point of along vertical section 34 and/or the protruding section 40, respectively. According to an embodiment, the feed inlet structure 10 for a burner 4 for a suspension smelting furnace 20, such as the feed inlet structure 10 of for instance FIGS. 2, 3a, 3b, and 3c, may comprise a rectangular vertical cross section at least at one point along the protruding section 40 and an elliptical, preferably round, horizontal cross section at least at one point along the vertical section 34. According to an embodiment, the vertical section 34 may comprise a round horizontal cross section at least at the bottom 12, where the feed inlet structure 10 connects to the feed material discharge channel 5

According to an embodiment, the vertical section 34 and the protruding section 40 may be connected to each other in such a manner that the inside spaces of the vertical section 34 and the protruding section 40 are connected to each other. The vertical section 34 and/or the protruding section 40 may consist of one or several structural parts. According to an embodiment, the protruding section 40 may be connected to and/or comprise a part of a feed tube or a conveyor.

The side wall(s) 11 may, thus, in different embodiments and in different parts, portions and sections of the feed inlet structure 10, extend in any direction, also in a horizontal direction or a direction comprising a horizontal component.

According to an embodiment, the inlet space 14 may comprise the inside space of the protruding section 40. According to an embodiment, the inlet space 14 may comprise the inside space of both the protruding section 40 and the vertical section 34.

The feed inlet structure 10 further comprises an inlet opening 15 provided in at least one side wall 11. According to an embodiment, the inlet opening 15 is provided at the end of the protruding section 40 directed away from the vertical section 34. According to an embodiment, the inlet opening 15 may be configured to connect the inlet space 14 to a feed tube or a conveyor or a part thereof supplying feed material into the feed inlet structure 10.

According to an embodiment, an inlet bottom 39 may be provided in the feed inlet structure 10 adjacent to a lower edge of the feed inlet opening 15. According to an embodiment, the feed inlet bottom 39 may be provided adjacent to the inlet opening 15 in the side wall 11, in which the inlet opening 15 is provided.

According to an embodiment, a portion of a pair of side walls 11, a portion of the top 13 and the feed inlet bottom 39 may form a protruding section 40 of the feed inlet structure 10. According to such an embodiment, the inlet opening 15 may be defined by inlet edges of the pair of side walls 11, the feed inlet bottom 39 and the top 13. According to an alternative embodiment, one side wall 11, such as a side wall 11 comprising a cross section having a shape of a segment of a circle and the feed inlet bottom 39 may form a protruding section 40 of the feed inlet structure 10. The side wall 11 may, thus, also form a portion of the top 13, more particularly the portion of the top 13 forming the top of the protruding section 40. According to such an embodiment, the inlet opening 15 may be defined by inlet edges of the side wall 11 and the feed inlet bottom 39. The inlet edges of the side wall(s) 11, the feed inlet bottom 39 and the top 13 refer to the edges directed towards the inlet opening 15, in other words the edges directed towards the front end of the feed inlet structure.

According to an embodiment, the inlet space 14 may, instead of referring to the whole inside volume of the feed inlet structure 10, alternatively refer to the inside space of the protruding section 40 only. According to an embodiment, the inlet space 14 may refer to a space defined by the portion of a pair of side walls 11 provided on the sides of the inlet opening 15, the feed inlet bottom 39 and the portion of the top 13 of the feed inlet structure 10 as well as imaginary planes at the inlet opening 15 and at a distal end opening 35 connecting the protruding section 40 to the vertical section 34 of the feed inlet structure 10. In such an embodiment, the inlet opening 15 and the distal end opening 35 may be provided at opposite ends of the inlet space 14 and defined by edges of the portions of the side walls 11, the feed inlet bottom 39 and the portion of the top 13 directed towards each of the ends, respectively. These ends can be called front end and back end in the direction of the intended feed material flow, wherein the front end is the first end in the direction of the intended feed material flow and the back end is the second end in the direction of the intended feed material flow. In other words, the feed inlet structure 10 may be configured to receive the feed material at the first end and to discharge the feed material to the vertical section 34 at the second end of the feed inlet structure 10.

The feed inlet structure 10, such as the feed inlet structure of FIG. 3a, 3b, 3c, 4a, 4b or 4c, further comprises a feed distributor 16 provided at least partly within the inlet space 14. The feed distributor 16 may be configured to separate objects from a standard feed, which objects have a particle size that is larger than a maximum particle size of the standard feed. The feed distributor 16 being provided at least partly within the inlet space 14 means that at least a part of the feed distributor 16 is provided within the inlet space 14. A part or portion of the feed distributor 16 may, thus, extend beyond the feed inlet space 14. According to an embodiment, the feed distributor 16, in other words the entire feed distributor 16, is provided within the inlet space 14.

According to an embodiment, the feed inlet structure 10 may, thus, further comprise a vertical section 34. This vertical section 34 may comprise a vertical tube-like chamber. The feed inlet structure 10 may also comprise a protruding section 40 defined by a portion of a pair of side walls 11, a portion of the top 13 and a feed inlet bottom 39. The tube-like chamber of the vertical section 34 may connect to the protruding section 40 via a distal end opening 35. According to an embodiment, the vertical section 34 may further connect to the feed material discharge channel 5 at a lower end of the vertical section 34.

Standard feed of a suspension smelting furnace 20, for instance, typically comprises fine solids. According to an embodiment, the particle size of standard feed may be smaller than or equal to 2 mm. However, the feed material may also comprise larger objects in addition to the standard feed. These larger objects may comprise for instance agglomerated dust lumps, large reverts, large chunks of eScrap, bag parts, plastics, rods, gloves, tools and/or similar. According to an embodiment, for instance an embodiment, where the objects comprise objects of round or rounded shape, such as dust lumps and/or large reverts, at least one dimension of the objects, such as the largest diameter of the objects, may be for instance in the range of 50-200 mm, in the range of 70-200 mm or in the range of 90-250 mm. According to an embodiment, for instance an embodiment, where the objects comprise objects of more irregular shape, such as eScrap, bag parts, plastics, rods, gloves and/or tools, at least one dimension of the objects, such as the longest measured dimension of the objects, may be in the range of 50-500 mm, in the range of 70-500 mm, or in the range of 90-500 mm. The feed material of the burner may, thus, comprise standard feed and objects. An asymmetric material feed to the burner 4 may lead to an uneven suspension causing melt reactions and residual oxygen to the gas line. These may lead to an increased slag losses for example for copper or nickel, and increased weak acid formation due to the excess oxygen. It may also increase dust formation due to an increased share of overoxidized particles.

According to an embodiment, the feed inlet structure 10 may receive feed material via inlet opening 15 for instance from a feed tube or a conveyor (not shown). According to an embodiment, the feed tube or the conveyor may be provided at a downward angle in the range of 4-10 degrees towards the feed inlet structure 10. When received in the feed inlet structure 10, the feed material has an initial velocity. When the feed material enters the feed inlet structure 10, the initial velocity and gravity affect a trajectory of the feed material guiding the feed material inwards and downwards within the feed inlet structure 10. One purpose of feed distributors 16, feed inlet structures 10 and methods disclosed in this description is to deviate the trajectories of the standard feed and the objects from one another by the first sides 18, and more particularly first surfaces 19, of the feed distributor 16.

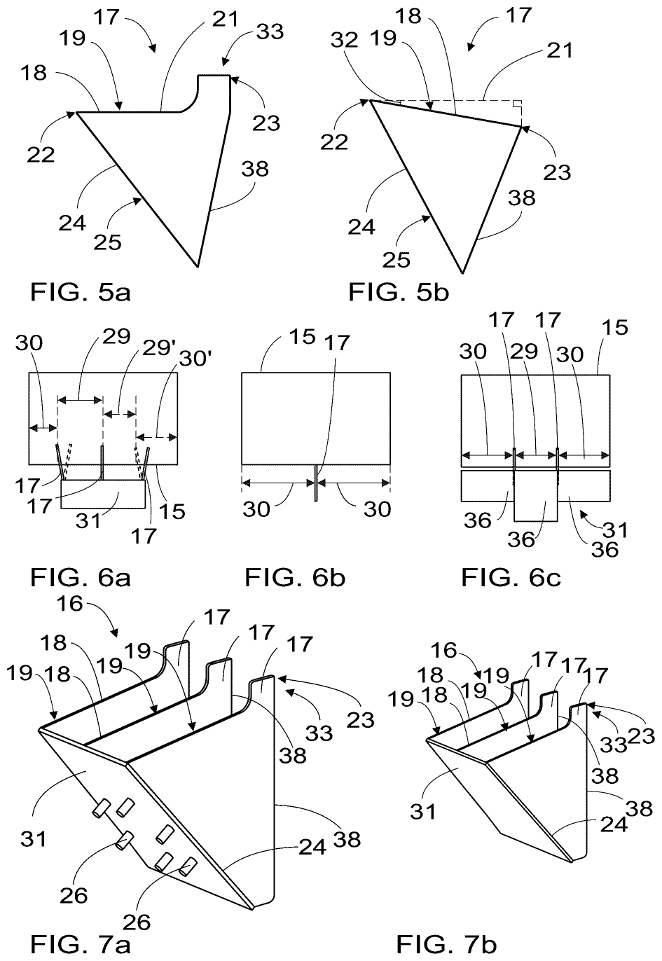

The feed distributor 16 comprises at least one dividing plate 17. FIGS. 5a and 5b illustrate schematically two embodiments of a dividing plate 17 seen from a side as partially transparent. The dividing plates 17 in FIGS. 5a and 5b are shown in positions illustrating the positions of the dividing plates 17 in a typical use position of the feed inlet structure 10. The dividing plate 17, such as the dividing plate of FIG. 5a or 5b, comprises a first side 18 having a first surface 19. The first side 18 is configured to have a horizontal component 21, an inlet end 22 directed towards the inlet opening 15, and a distal end 23 at the end opposite to the inlet end 22. More particularly, the first side 18 may comprise the horizontal component 21 in a use position of the feed inlet structure 10. Thereby, the first surface 19 of each dividing plate 17 may be configured to deviate a trajectory of at least some objects 27 from a trajectory of the standard feed 28 inside the feed inlet structure 10, when feed material comprising standard feed and objects is fed to the feed inlet structure, as best seen in FIGS. 4a, 4b and 4c. A deviation angle 32, as illustrated in FIG. 5b, may be directed downwards from the horizontal direction, as in the embodiments of FIGS. 4b and 5b, or it may be directed upwards, as in the embodiment of FIG. 5c. The concepts of downwards and upwards directions are explained in more detail in connection with other embodiments in this description.

In the context of this description and accompanying drawings and claims, a use position, such as a use position of the feed inlet structure 10, refers to a typical position in which the structure, such as the feed inlet structure 10, is provided during production use.

In the context of this description and accompanying claims and drawings, the term vertical direction refers to the direction of the acceleration due to gravity vector and horizontal refers to a direction perpendicular to the vertical direction.

In the context of this description and accompanying claims and drawings, the first side 18 being configured to have a horizontal component 21 may refer to the first side 18 extending in a direction of flow of feed material comprising the objects and the standard feed. In the context of this description and accompanying claims and drawings, the first side 18 being configured to have a horizontal component 21 may also refer to the first side 18 extending in a direction perpendicular to a plane defined by the inlet opening 15. In other words, the first side 18 may be configured to extend from the inlet opening 15 towards the back end of the inlet structure 10.

According to an embodiment, the first side 18 extends at the distal end 23 to the distal end opening 35, to the vicinity of the distal end opening 35, or through the distal end opening 35 into the vertical section 34.

According to an embodiment, the feed inlet structure 10 may have a bend in at least one side wall 11 provided towards the inlet opening 15 at distal end opening 35, where the protruding section 40 connects to the vertical section 34 of the feed inlet structure 10. In other words, at least one side wall 11, more particularly at least one side wall 11 adjacent to the lower edge of the inlet opening 15, comprises a bend at the point where the protruding section 40 connects to the vertical section 34, which point is located at the distal end opening 35, as in the embodiments of FIGS. 2, 4a, 4b and 4c. According to an embodiment, at least one of the dividing plates 17, and preferably each of the dividing plates 17, is configured to extend to the distal end opening 35 defined at the bend where the protruding section 40 connects to the vertical section 34, to the vicinity of the distal end opening 35, or beyond the distal end opening 35 to the inside of the vertical section 34. The one or more dividing plates extending to the vicinity of the distal end opening 35 means that distance of the distal end 23 of the first side 18 and the distal end opening 35 is not more than 100 mm towards the inlet opening 15. In other words, the distal end 23 of the at least one dividing plate 17 may be provided in the area extending from a point 100 mm from the distal end opening 35 towards the inlet opening 15 and the inside of the vertical section 34.

According to an embodiment, the first surface 19 of each dividing plate 17 may be provided in an angled direction with respect to the feed inlet bottom 39 of a feed inlet structure 10 in embodiments comprising a feed inlet bottom 39. In other words, a direction extending from the inlet end 22 of the first side 18 to the distal end 23 of the first side 18 would be provided at an angle with respect to a direction extending from the inlet end 22 of the feed inlet bottom 39 towards an opposite end of the feed inlet bottom 39. Thus, the first surface 19, the first side 18 and the feed inlet bottom 39 may or may not be formed as straight shapes, as the directions angled with respect to each other are defined by their end points. However, in case the first side 18 and/or the feed inlet bottom 39 is provided one or more protrusions at either end of the first side 18 and/or the feed inlet bottom 39, these protrusions may be excluded from this definition and the directions angled with respect to each other may be defined by points closest to respective end and next to such protrusion.

According to an embodiment, each dividing plate 17 may further comprise a second side 24 having a second surface 25. The second side 24 may connect to the inlet end 22 of the first side 18 and the second side 24 may be provided in an angled direction with respect to the first side 18. According to an embodiment, the second surface 25 may be configured to conform to a shape of the feed inlet bottom 39 of the feed inlet structure 10. Similarly to what is said above regarding protrusions when defining angles between the first side 18 and the second side 24, such protrusions may be excluded from the definition.

According to an embodiment, the first surface 19 of each dividing plate 17 may be configured to receive at least some of the objects or parts of the objects received to the inlet space 14 through the inlet opening 15 and to guide them inside the feed inlet structure 10 in a direction of the first side 18 towards the distal end 23 of the first side 18.

According to an embodiment, the feed distributor 16 may be provided with at least one mounting member 26 for mounting the feed distributor 16 inside the feed inlet structure 10. According to an embodiment, the mounting member 26 may comprise at least one of the following: a mounting hole, a mounting sleeve, a mounting flange and a bolt. A mounting hole may or may not be threaded. The feed inlet structure 10 may or may not comprise further mounting members, such as mounting hole(s), mounting sleeve(s) and/or mounting flange(s) configured in each case to be aligned with a corresponding mounting member 26 of the feed distributor 16. According to an embodiment, the feed distributor 16 may not comprise a mounting member 26. In such embodiments, the feed inlet structure 10 may comprise a mounting member, such as a flange or a stopper, configured to conform to at least one shape of the feed distributor 16 and to receive and retain the feed distributor 16 in its intended position with respect to the feed inlet structure 10. In such embodiments, the feed distributor 16 may, for instance, be configured to be slid to its position within the feed inlet structure 10.

According to an embodiment, the feed distributor 16 may comprise at least two dividing plates 17. The dividing plates 17 and the first surfaces 19 of the dividing plates 17 may be spaced from each other. Thereby the first surfaces 19 of the at least two dividing plates 17 may be configured to deviate a trajectory of the objects 27 from a trajectory of the standard feed 28 inside the feed inlet structure 10, when feed material is fed to the feed inlet structure 10. According to an embodiment, the feed distributor 16 may comprise exactly two or three dividing plates 17.

According to an embodiment, a distance 29 between the first surfaces 19 of the dividing plates 17 may be fixed. Similarly, a distance 30 between a side wall 11 of the feed inlet structure 10, especially the closest side wall 11 parallel or substantially parallel to the dividing plate 17, and the dividing plate 17 closest to it may be fixed.

According to an embodiment, the distance 29 between the first surfaces 19 of the dividing plates 17 may be adjustable. According to an embodiment, a position of at least one of the dividing plates 17 may be configured to be adjustable in the direction transverse with respect to the direction of the first side 18, whereby the distance 29 between the first surfaces 19 of the dividing plates 17 may be adjustable.

According to an embodiment, at least one dividing plate 17 may be attached in an articulated manner with respect to the feed inlet bottom 39 of the feed inlet structure 10. Such a dividing plate 17 may be mounted in an articulated manner directly to the feed inlet bottom 39 of the feed inlet structure 10 or a structure attached thereto, or indirectly via another structure of the feed distributor 16, such as a bottom plate 31 of the feed distributor 16, or the feed inlet structure 10. In such embodiments, the distance 29 between first surfaces 19 of adjacent dividing plates 17 and/or the distance 30 between a side wall 11 of the feed inlet structure 10, especially the closest side wall 11 parallel or substantially parallel to the dividing plate 17, and the dividing plate 17 closest to it may be configured to be adjustable by pivoting one or more dividing plates 17 about an axis. Such pivoting, or articulation, and adjustment of the distances 29, 30 is illustrated by a dashed line in FIG. 6a.

According to an embodiment, the distance 29, namely a fixed distance or an adjusted distance, between the dividing plates 17 is in the range of 50-300 mm. According to an embodiment, the distance 30, namely a fixed distance or an adjusted distance, between a side wall 11 and the dividing plate 17 closest to the side is in the range of 50-300 mm. According to an embodiment, the distance 29 and/or the distance 30 is in the range of 70-250 mm. According to a further embodiment, the distance 29 and/or the distance 30 is in the range of 90-125 mm. It is clear for a person skilled in the art that the distances 29, 30 should be selected considering the particle size of the standard feed and the size of the objects the trajectory of which is intended to be deviated.

According to an embodiment, the first side 18 of each dividing plate 17 may be provided in a direction horizontal, such as in FIGS. 4a and 5a, or deviating a maximum of 15 degrees downwards, such as in FIGS. 4b and 5b, or a maximum of 10 degrees upwards, such as in FIG. 4c, from a horizontal direction in the direction from the inlet end towards the distal end in a use position of the feed inlet structure. According to an embodiment, the first side 18 of each dividing plate 17 may be provided in a direction horizontal or deviating a maximum of 10 degrees downwards or a maximum of 7 degrees upwards from a horizontal direction in the direction from the inlet end towards the distal end in a use position of the feed inlet structure. In some embodiments, the first side 18 of each dividing plate 17 may be provided in a direction deviating more than 15 degrees downwards or more than 10 degrees upwards, if this is permitted by the type and initial velocity of the feed material, the overall configuration of the feed inlet structure 10 and the burner 4, and/or similar. The first side 18 deviating downwards from the horizontal direction means the distal end 23, or a point of the first side 18 closest to the distal end 23 before a possible vertical protrusion in the first side 18, is at a lower level than the inlet end 22, or a point of the first side 18 closest to the inlet end 22 after a possible vertical protrusion in the first side 18. A deviation angle 32 is defined by a line drawn between these points and/or ends. A downwards deviation may be preferable in many embodiments, but an upwards deviation may be preferable for instance in embodiments with a higher than average capacity and/or feed rate.

According to an embodiment, at least one of the dividing plates 17 may comprise a protruding portion 33 protruding upwards from the first surface 19 in a use position of the feed inlet structure 10, wherein the protruding portion 33 is provided at the distal end 23 of the first side 18. Such a protruding portion 33 is an example of a protrusion, or a vertical protrusion, mentioned in this description.

According to an embodiment, the feed distributor 16 may further comprise a bottom plate 31 configured to extend between the dividing plates 17. According to an embodiment, the bottom plate 31 may be configured to be mounted to the feed inlet bottom 39 of the feed inlet structure 10. According to an embodiment, the bottom plate 31 is provided in a direction parallel to the feed inlet bottom 39 of the feed inlet structure 10. The bottom plate 31 and the feed inlet bottom 39 being parallel means the planes defined by the bottom plate 31 and the feed inlet bottom 39 are parallel to each other or deviate from each other by a maximum angle of 15 degrees.

According to an embodiment, the feed inlet bottom 39 or the bottom plate 31 may comprise sections 36 in a direction parallel to the direction of the dividing plate(s) 17. In other words, the feed inlet bottom 39 or the bottom plate 31 may comprise sections 36 each extending from the inlet opening 15 towards the distal end 23 and the possible vertical section 34. According to an embodiment, a dividing plate 17 may be provided where two adjacent sections 36 connect. According to an embodiment, one or more of the sections 36 may be provided at a different angle with respect to at least one other section 36. According to an embodiment, at least one section 36 provided between two other sections may comprise a deeper downward angle towards the distal end opening 35 than the sections 36 closer to or adjacent to the side walls 11, especially the closest side wall(s) 11 parallel or substantially parallel to the dividing plate 17.

According to an embodiment, the feed inlet bottom 39 and/or the bottom plate 31 may be provided at an angle of 37 equal to or larger than 25 degrees with respect to a horizontal direction in a use position of the feed inlet structure 10. According to an embodiment, more particularly an embodiment where the feed inlet bottom 39 or the bottom plate comprises sections 36, the sections 36 provided adjacent to the side walls 11, especially the closest side wall(s) 11 parallel or substantially parallel to the dividing plate 17, may be provided at an angle 37 equal to or larger than 25 degrees with respect to a horizontal direction in a use position of the feed inlet structure 10, and at least one section 36 provided between the sections adjacent to the side walls 11 is provided at an angle larger 37 than the angle 37 of the sections adjacent to the side walls 11, for instance at an angle equal to or larger than 45 degrees.

According to an embodiment, each of the dividing plates 17 may comprise a third side 38 extending between the second side 24 and distal end 23 of the first side 18 or between the second side 24 and the protruding portion 33. According to an embodiment, the first surface 19, the second side 24 and the third side 38 may form a triangular shape. In embodiments comprising protrusions, such as a protruding portion 33, the protrusion may thus also protrude from this triangular shape. According to an embodiment, the third side 38 may have a vertical component in a use position of the feed inlet structure 10.

According to an embodiment, the feed inlet structure 10 may further comprise a hatch (not shown) for accessing material within the inlet space 14. Particularly, the hatch may be used for accessing and removing such objects that are not intended to be fed to the burner 4. According to an embodiment, the hatch may be provided in the top 13 and/or a side wall 11 of the feed inlet structure 10. Such a hatch may be provided for instance at the end of the top 13 directed towards the inlet opening 15, at the end of the top 13 directed away from the inlet opening 15, in one of the side walls 11 extending from the inlet opening 15 towards the opposite end of the feed inlet structure 10, namely towards the back end of the feed inlet structure provided opposite to the front end directed towards the inlet opening 15, and/or in a side wall 11 at the back end of the feed inlet structure 10. Such hatches for other types of maintenance purposes are known in the art and are, therefore, not disclosed here in more detail.

According to an embodiment, the feed inlet structure 10 may comprise two inlet openings 15 provided at opposite sides of the feed inlet structure 10, such as in the embodiment of FIG. 4b. According to an embodiment, one feed distributor 16 may be provided in connection with each inlet opening 15. In other words, a feed distributor 16 according to an embodiment or a combination of embodiments may be provided adjacent to each inlet opening 15. According to an embodiment, a protruding section comprising a top 13, a feed inlet bottom 39 and a pair of side walls 11 may be provided in connection with each inlet opening 15 and defining an inlet space 14 adjacent to each inlet opening 15 in a manner similar to embodiments comprising a single inlet opening 15. In such embodiments, one feed distributor 16 may be provided within each inlet space 14 of the feed inlet structure 10 or within at least one of the inlet spaces 14. According to a further embodiment, each inlet space 14 may connect to a common vertical section 34 via a separate distal end opening 35. According to an alternative embodiment, the whole inside of the feed inlet structure 10 defined by at least one side wall 11, for instance two pairs of side walls 11, a top 13 and a bottom 12 may form the inlet space 14 in a manner similar to some other embodiments comprising a single inlet opening 15 described above. Also in such embodiments, one feed distributor 16 may be provided within each inlet space 14 of the feed inlet structure 10 or within at least one of the inlet spaces 14, and/or each inlet space 14 may connect to a common vertical section 34 via a separate distal end opening 35.

According to an embodiment, a burner 4 may comprise a feed distributor 16 and/or a feed inlet structure 10 according to an embodiment or a combination of embodiments disclosed in this description and accompanying drawings and claims. According to an embodiment, the burner 4 comprises a burner for a suspension smelting furnace According to an embodiment, the burner 4 may comprise a concentrate burner or a matte burner.

According to an embodiment, the burner 4 may comprises two inlet spaces 14 provided opposite to each other in such a manner that the inlet openings 15 of the inlet spaces 14 are directed away from each other, the distal ends 23 of the first sides 18 are directed towards each other. Depending on the embodiment, the inlet spaces 14 may form separate feed inlet structures 10 or form parts of a same feed inlet structure. The feed inlet structure 10 may or may not comprise a vertical section 34. According to an embodiment, feed material is configured to be guided forward from the inlet spaces 14 to a shared channel after passing in each case one of the feed distributors 16. According to an embodiment, the shared channel may comprise the vertical section 34. The vertical section 34 may form a part of the feed inlet structure 10 or it may be provided as a separate structural part.

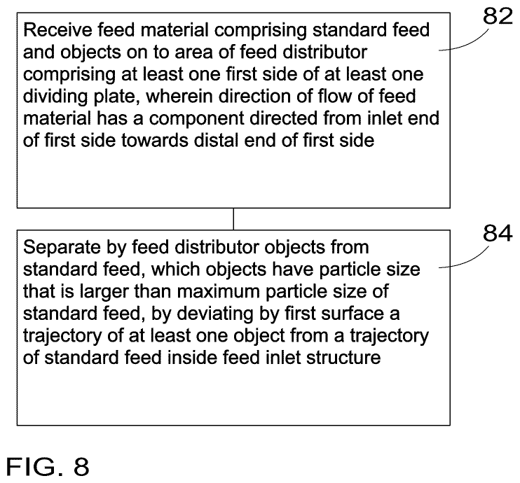

FIG. 8 illustrates a method for feeding material to a burner for a suspension smelting furnace. The burner 4, such as a burner for a suspension smelting furnace, may comprise a feed inlet structure according to an embodiment or a combination of embodiments disclosed in this description and accompanying drawings and claims. A method for feeding material to such a burner, such as the method according to FIG. 8, may comprise receiving 82 feed material comprising standard feed and objects on to an area of the feed distributor 16 comprising at least one first side 18 of at least one dividing plate 17. The direction of the flow of the feed material may have a component directed from the inlet end 22 of the first side 18 towards the distal end 23 of the first side 18. In other words, the direction of the flow of the feed material may comprise a horizontal component.

The method may further comprise separating 84 by the feed distributor 16 objects from a standard feed, which objects have a particle size that is larger than a maximum particle size of the standard feed. The separating of the objects may be implemented by deviating by the first surface 19 a trajectory 27 of at least one object from a trajectory 28 of the standard feed inside the feed inlet structure 10, more particularly inside the inlet space 14. More particularly, the trajectory 27 of the objects may be deviated by the first surface 19 of at least one dividing plate 17 affecting at least one object. The affecting may comprise the object being brought to contact with the first surface 19 along its trajectory and being stopped or guided further towards the distal end 23 of the first side 18 by the first surface 19. Thereby, the first surface 19 may prevent the object from continuing on its trajectory 27 defined by the initial velocity of the object and the gravity, and instead deviates the object towards the distal end 23 along the first surface 19. Simultaneously, the trajectory 28 of the standard feed may be unaffected or only mildly affected by the first surface(s) 19 due to the smaller particle size of the standard feed. It is clear for a person skilled in the art that while the particle size of the standard feed may vary depending on the embodiment, the size of the objects the trajectory 27 of which is configured to be deviated is defined by the selected distance 29 between first surfaces 19 of adjacent dividing plates 17 and/or the distance 30 between a side wall 11 of the feed inlet structure 10 and the dividing plate 17 closest to it.

According to an embodiment, the method may further comprise receiving on the first surfaces 19 of the dividing plate(s) 17 at least some of the objects or parts of the objects received to the inlet space through the inlet opening, and guiding said objects inside the feed inlet structure in a direction of the first side from the inlet opening towards the distal end of the first side.

According to an embodiment, the method further comprises providing adjacent dividing plates 17 at such a distance from each other that the shortest distance 29 between the first surfaces 19 of the adjacent dividing plates 17 is shorter than at least one dimension, such as at least the largest dimension, of the smallest object a trajectory 27 of which is determined to be deviated from the trajectory 28 of the standard feed.

According to an embodiment, the method further comprises adjusting a position of at least one dividing plate 17 in a direction transverse to the direction of the flow of the feed material to affect the size range of objects for which a trajectory 27 is deviated from the trajectory 28 of the standard feed. The adjusting of the position of at least one dividing plate 17 may comprise adjusting the distance 29 between first surfaces 19 of adjacent dividing plates 17 and/or the distance 30 between a side wall 11 of the feed inlet structure 10, especially the closest side wall 11 parallel or substantially parallel to the dividing plate 17, and the dividing plate 17 in question. The adjusting of the position of at least one dividing plate 17 may comprise pivoting one or more dividing plates 17 about an axis. Adjusting the position of at least one dividing plate 17 may also affect how evenly standard feed is supplied to the feed material discharge channel 5, which may otherwise be affected for instance by a 10 change in a condition of the feed inlet structure 10 and/or other feeding equipment, such as the wear thereof.

According to an embodiment, the horizontal component of the first sides 17 of the dividing plates 17 are configured to extend in a direction of the flow of feed material.

1.-26. (canceled)

27. A feed inlet structure for a burner for a suspension smelting furnace, the feed inlet structure comprising:
at least one side wall,
a bottom and a top provided at opposite ends of the at least one side wall,
an inlet space defined inside the feed inlet structure, and
an inlet opening provided in at least one side wall, wherein the feed inlet structure further comprises:
a feed distributor provided at least partly within the inlet space,
wherein the feed distributor is configured to separate objects from a standard feed, which objects have a particle size that is larger than a maximum particle size of the standard feed, and
wherein the feed distributor comprises at least one dividing plate comprising a first side having a first surface, wherein the first side is configured to have a horizontal component, an
inlet end directed towards the inlet opening, and a distal end at the end opposite to the inlet end,
whereby the first surface of each dividing plate is configured to deviate a trajectory of at least some objects from a trajectory of the standard feed inside the feed inlet structure, when feed material comprising standard feed and objects is fed to the feed inlet structure.

28. The feed inlet structure according to claim 27, wherein the first surface of each of said dividing plates is provided in an angled direction with respect to a feed inlet bottom provided in the feed inlet structure adjacent to a lower edge of the feed inlet opening.

29. The feed inlet structure according to claim 27, wherein each of said dividing plates further comprises:
a second side having a second surface, wherein the second side connects to the inlet end of the first side and is provided in an angled direction with respect to the first side.

30. The feed inlet structure according to claim 27, wherein the first surface of each of the dividing plates is configured to receive at least some of the objects or parts of the objects received to the inlet space through the inlet opening and to guide them inside the feed inlet structure in a direction of the first side towards the distal end of the first side.

31. The feed inlet structure according to claim 27, wherein the feed distributor comprises at least two dividing plates, and
wherein the dividing plates and the first surfaces of said dividing plates are spaced from each other,
whereby the first surfaces of the at least two dividing plates are configured to deviate a trajectory of the objects from a trajectory of the standard feed inside the feed inlet structure, when feed material is fed to the feed inlet structure.

32. The feed inlet structure according to claim 31, wherein the feed distributor comprises exactly two or three dividing plates.

33. The feed inlet structure according to claim 31, wherein a position of at least one of the dividing plates is configured to be adjustable in the direction transverse with respect to the direction of the first side, whereby the distance between the first surfaces of the dividing plates is adjustable.

34. The feed inlet structure according to claim 31, wherein the distance between the dividing plates is in the range of 50-300 mm.

35. The feed inlet structure according to claim 27, wherein the first side of each dividing plate is provided in a direction horizontal or deviating a maximum of 15 degrees downwards or a maximum of 10 degrees upwards from a horizontal direction in the direction from the inlet end towards the distal end in a use position of the feed inlet structure.

36. The feed inlet structure according to claim 27, wherein at least one of the dividing plates comprises a protruding portion protruding upwards from the first surface in a use position of the feed inlet structure, wherein the protruding portion is provided at the distal end of the first side.

37. The feed inlet structure according to claim 27, wherein the feed inlet structure further comprises a hatch for accessing material within the inlet space.

38. The feed inlet structure according to claim 27, wherein the feed inlet structure comprises a rectangular cross section at least at one point along the feed inlet structure, and wherein the at least one side wall comprises four side walls comprising two pairs of side walls, each pair of side walls comprising two side walls spaced from each other.

39. The feed inlet structure according to claim 27, wherein
the feed inlet structure comprises a vertical section and a protruding section, and wherein at least one of the dividing plates is configured to extend to a distal end opening defined at a bend where the protruding section connects to the vertical section, to the vicinity of the distal end opening, or beyond the distal end opening to the inside of the vertical section.

40. The feed inlet structure according to claim 27, wherein the feed inlet structure comprises two inlet openings provided at opposite sides of the feed inlet structure, and wherein one feed distributor is provided in connection with each inlet opening.

41. A burner for a suspension smelting furnace, wherein the burner comprises a feed inlet structure according to claim 27.

42. The burner according to claim 41, wherein the burner comprises two inlet spaces provided opposite to each other in such a manner that the inlet openings of the inlet spaces are directed away from each other and the distal ends of the first sides are directed towards each other, and wherein the feed material is configured to be guided forward to a shared channel after passing in each case one of the feed distributors.

43. The method for feeding material to a burner for a suspension smelting furnace, wherein the burner comprises a feed inlet structure according to claim 27, wherein the method comprises:
receiving feed material comprising standard feed and objects on to an area of the feed distributor comprising at least one first side of at least one dividing plate, wherein the direction of the flow of the feed material has a component directed from the inlet end of the first side towards the distal end of the first side, and
separating by the feed distributor objects from a standard feed, which objects have a particle size that is larger than a maximum particle size of the standard feed, by deviating by the first surface a trajectory of at least one object from a trajectory of the standard feed inside the feed inlet structure.

44. The method according to claim 43, wherein the method further comprises:
receiving on the first surface of said dividing plate at least some of the objects or parts of the objects received to the inlet space through the inlet opening, and
guiding said objects inside the feed inlet structure in a direction of the first side from the inlet opening towards the distal end of the first side.

45. The method according to claim 43, wherein the method further comprises:
providing adjacent dividing plates at such a distance from each other that the shortest distance between the first surfaces of the adjacent dividing plates is shorter than the at least one dimension of the smallest object a trajectory of which is determined to be deviated from the trajectory of the standard feed.

46. The method according to claim 43, wherein the method further comprises:
adjusting a position of at least one dividing plate in a direction transverse to the direction of the flow of the feed material to affect the size range of objects for which a trajectory is deviated from the trajectory of the standard feed.
